(19) United States
(12) Patent Application Publication
(10) Pub. No.: US 2011/0304543 A1
(43) Pub. Date: Dec. 15, 2011

(54) WIRELESS MOUSE CAPABLE CONTROLLING MULTIPLE COMPUTING DEVICES

(76) Inventor: Tianlong Chen, Gaithersburg, MD (US)

(21) Appl. No.: 12/815,060

(22) Filed: Jun. 14, 2010

(51) Int. Cl. G09G 5/08

(52) U.S. Cl. 345/163

(57) ABSTRACT

A method to implement a wireless mouse capable of controlling multiple computing devices is disclosed. The disclosed wireless mouse has a means to store identifications of multiple signal receivers which are each connected to or are each part of a computing device; the disclosed wireless mouse has a means to select one of multiple signal receivers such that one of multiple computing devices (which has connection with selected signal receiver) as target to receive position (pointing) information for further action by the targeted computing device.

### FIELD OF THE INVENTION

The present invention is related to a wireless mouse capable of controlling multiple computing devices.

### BACKGROUND OF THE INVENTION

Current wireless mouse can only connect to one computing device (including, but not limited to, laptop computer, desktop computer, handheld PDA, and so on) through its pairing signal receiver that is either directly connected to the computing device or part of the computing device. If you have multiple computing devices and if you use a wireless mouse for each computing device, you may have several wireless mice in front of you, you will get confused by which mouse is connected to which computing device; therefore it is very inconvenient. The disclosed invention is a wireless mouse capable of controlling multiple computing devices.

### ABSTRACT

A method to implement a wireless mouse capable of controlling multiple computing devices is disclosed. The disclosed wireless mouse has a means to store identifications of multiple signal receivers which are each connected to or are each part of a computing device; the disclosed wireless mouse has a means to select one of multiple signal receivers such that one of multiple computing devices (which has connection with selected signal receiver) as target to receive position (pointing) information for further action by the targeted computing device.

### SUMMARY OF THE INVENTION

The present invention is related to a wireless mouse capable of controlling multiple computers; the single wireless mouse can control multiple computing devices providing each computing device having a signal receiver pairing with the wireless mouse. Wireless mouse usually has a signal transmitter to transmit signal to a signal receiver that connected to a computing device to transfer position and other information; the transmitted signal could be Radio Frequency (RF) operated at 2.4 GHz or other frequency, or Bluetooth RF, or other signal types; the transmitted signal includes an identification code pairing the wireless mouse and its related receiver. The present invention is that the wireless mouse can select multiple different identification codes each pairing with one unique signal receiver to be able to control multiple computing devices; the invented wireless mouse has a means to change from one identification code to another in order to select which computing device a user wants to connect to.

### BRIEF DESCRIPTION OF THE DRAWINGS

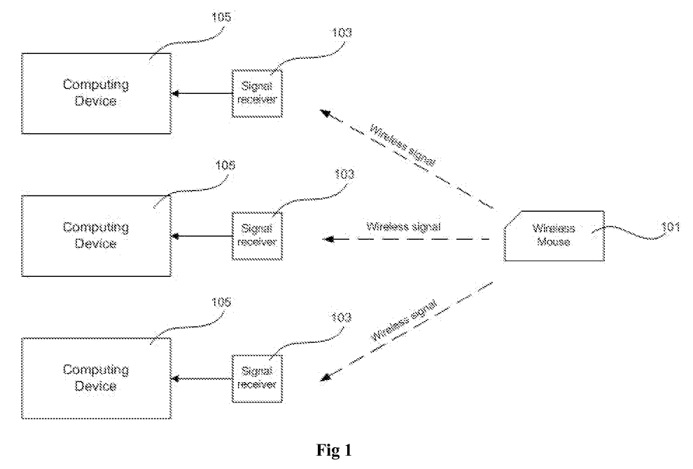

The FIG. 1 is a block diagram illustrating an exemplary wireless mouse capable of controlling multiple computer devices.

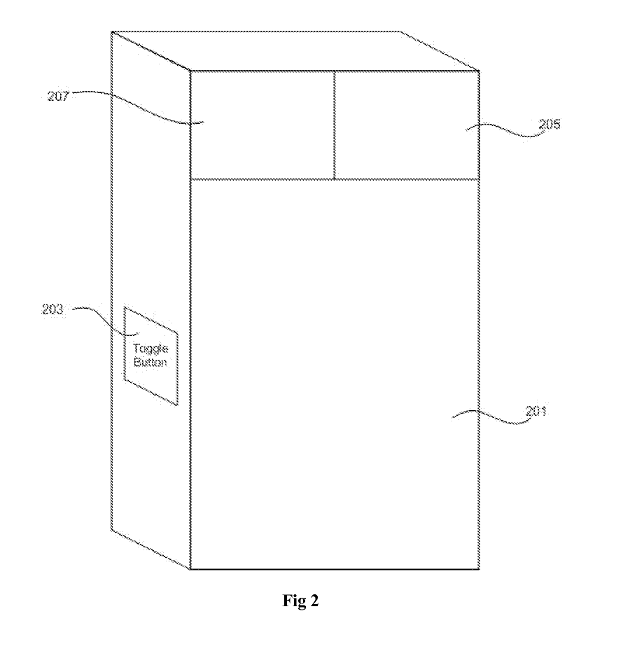

The FIG. 2 is a block diagram illustrating an exemplary wireless mouse that has a toggle button; when the toggle button is pushed, the wireless mouse will loop through multiple signal receivers by embedding different identification codes.

### DESCRIPTION OF THE PREFERRED EMBODIMENT

Wireless mouse has a signal transmitter to transmit signal to its pairing signal receiver which is connected to a computing device or is part of the computing device to providing position and other information to the computing device. The transmitted signal could be Radio Frequency (RF) signal operating at 2.4 GHz or other frequency, or could be Bluetooth RF, or could be other signals that can carry the information (referred to “carried information” hereafter for simplified description purpose) which at least includes position (pointing) information to a targeted computing device. An identification code is embedded inside the carried information such that the signal receiver pairing with the signal transmitter of the wireless mouse will recognize the identification code and pass the position (or pointing) information to said computing device for action, whereas a signal receiver that does not recognize the identification code will ignore or drop the position information without passing to its attached computing device for action; normally one identification code will be recognized by only one signal receiver to transfer position information to the computing device that the signal receiver is connected to (or the signal receiver may be part of the computing device) for possible action.

The FIG. 1 is a functional block diagram illustrating an exemplary embodiment that one single invented wireless mouse 101 controls multiple computing devices 105; the wireless mouse 101 can generate multiple different identification codes. Each time the wireless signal transmitted by the wireless mouse 101 includes only one unique identification code that will be recognized by one signal receiver 103 which may trigger further action in its connected computing device 105.

The FIG. 2 is a functional block diagram illustrating an exemplary embodiment of invented wireless mouse 201. The wireless mouse like a regular wireless mouse 201 may has a left button 207 and right button 205, it also has a toggle button 203 that toggles through each of multiple identification codes such that one of identification codes will be selected and embedded in the signal transmitted from wireless mouse to signal receivers. The illustrated wireless mouse is only an exemplary shape used for description of the present invention, wireless mouse could have many different shapes and many other buttons or balls or other means to provide position (or pointing) information; the illustrated toggle button is also one of many possible means that could be used to select one of identification codes in signal transmitted to identify targeted signal receiver and its connected computing device to interact with. When toggle button is not pushed, the last selected (or a default if first-time use) identification code will be used in signal transmitted by the wireless mouse until toggle button is pushed to select a new one. If only one identification code is registered to the wireless mouse, pushing toggle button will not change the identification code.

Multiple identification codes from multiple signal receivers could be registered in the wireless mouse at manufacturing time, or could be registered dynamically later by user. The wireless mouse having a storage means to remember multiple identification codes.

For a more user-friendly embodiment, a visual light can be built in the signal receiver such that when it is selected the visual light will be turned on, and the visual light will be turned off when it is not selected. Other means can be used for such purpose, such as a selected computing device shows its “selected” status by shaking its point curse a few times, and so on.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for implementing a wireless mouse that is capable of controlling multiple computing devices, each computing device having a signal receiver to receive signal transmitted from said wireless mouse, and said signal including at least position (or pointing) information and identification code, and each identification code uniquely identifies a said signal receiver, comprising the steps of:
providing said wireless mouse having a storage means to remember multiple identification codes of said signal receivers;
providing said wireless mouse having a selection means to select which first signal receiver among a plurality of signal receivers is the targeted signal receiver that said wireless mouse transfers signal to;
wherein said first signal receiver then can pass the position information to its computing device for action.

2. A method for implementing a wireless mouse that is capable of controlling multiple computing devices, each computing device having a signal receiver to receive signal transmitted from said wireless mouse, and said signal including at least position (or pointing) information and identification code, and each identification code uniquely identifies a said signal receiver, comprising the steps of:
providing said wireless mouse having a storage means to remember multiple identification codes of said signal receivers;
providing said wireless mouse having a selection means to select which first signal receiver among a plurality of signal receivers is the targeted signal receiver that said wireless mouse transfers signal to;
providing that said signal receiver or its said computing device further includes a visual means to show that said signal receiver and its said computing device is selected to receive signal from said wireless mouse for further action by said computing device;
wherein said first signal receiver then can pass the position information to its computing device for action.
